(19) United States
(12) Patent Application Publication
(10) Pub. No.: US 2003/0012906 A1
(43) Pub. Date: Jan. 16, 2003

(54) Multilayer resin tube

(76) Inventor: Keita Suzuki, Nagoya-shi (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/030,095

(22) PCT Filed: May 28, 2001
(86) PCT No.: PCT/JP01/04428

(30) Foreign Application Priority Data
Jun. 7, 2000 (JP) 2000-170917

(51) Int. Cl. B32B 1/08

(52) U.S. Cl. 428/36.91

(57) ABSTRACT

This invention provides a tube having higher interlaminar strength without deteriorating good characteristics of a conventional resin tube by attracting attention on the material and constitution of the resin tube. The multi-layer resin tube of this invention is provided with a body layer 14 consisting of a thermoplastic resin and a barrier layer 18 consisting of a thermoplastic resin controlling fuel permeation in this order from the side of an outer layer thereof, wherein the barrier layer 18 is gradient-constituted such that said layer is rich in an adhesive component at the side of an outer layer and to be rich in a barrier component at the side of an inner layer.

### TECHNICAL FIELD

The present invention relates to a fuel tube for automobiles and in particular to a multi-layer resin tube for lower fuel permeation capable of coping with environmental regulation for automobiles.

### BACKGROUND ART

In recent years, the environmental regulation for automobiles tends to be increasingly severely restricted. For example, in the exhaust controls in California in the U.S., the regulation level was established (LEVII regulation) such that the amount of hydrocarbons discharged from one automobile is restricted within 0.5 g/test 24 hours. In Japan, low-pollution automobiles where the amount of fuel discharged is further reduced are increasingly used.

Accordingly, in the field of fuel tubes for automobiles, not conventional single-layer tubes but various multi-layer tubes provided therein with a resin layer (inner layer) having a barrier property (property of preventing fuel permeation) have been proposed as measures to prevent fuel permeation.

The multi-layer tubes should satisfy conditions such as an ability to endure stress from the outside by virtue of excellent shrinkage, strength etc., an ability to prevent passage of fuel, and chemical stability due to low reactivity with fuel, and those consisting of various materials and constitutions are conceivable.

In particular, tubes wherein a resin such as fluorine resin capable of controlling fuel permeation is used in the inner layer and a polyamide such as nylon 12 which is often used as a single-layer resin is used in the outer layer almost satisfy the above requirements.

The multi-layer resin tube is formed by thermally melting each resin and extruding it through a die thereby thermally fusing each layer. Because the fluorine resin and polyamide are inferior in adhesion, the tube is then provided with an intermediate layer for the purpose of adhesion therebetween (see JP-A 10-503263, JP-A 10-512653, U.S. Pat. No.5,884,671, U.S. Pat. No. 5,884,672 etc.).

A material comprising different kinds of materials forcibly laminated therein is easily broken by excessive force exerted on the joint area upon undergoing heating, mechanical force or the like. In particular, the fluorine resin has the disadvantage of poor adhesion, and the qualities, longevity etc. of the tube is considerably influenced depending on the manner of the above-mentioned adhesion.

The adhesion in said resin tube has been achieved by forming an adhesive layer (intermediate layer), and in consideration of the polarity, thermal expansion coefficient etc. of the adhesive layer relative to its adjacent resin, the material of the adhesive layer has been suitably selected.

The object of this invention is to provide a tube having higher interlaminar strength without deteriorating good characteristics (strength, barrier property etc.) of the conventional resin tube by attracting attention on the material and constitution of the resin tube.

### DISCLOSURE OF THE INVENTION

In the process of extensive study for solving the problem described above, the present inventors obtained a resin tube having the following constitution.

That is, the multi-layer resin tube used as a fuel tube for automobiles according to the present invention is provided with a body layer consisting of a thermoplastic resin and a barrier layer consisting of a thermoplastic resin controlling fuel permeation in this order from the side of an outer layer thereof,

wherein the barrier layer is gradient-constituted such that said layer is rich in an adhesive component at the side of an outer layer and to be rich in a barrier component at the side of an inner layer.

For keeping good qualities of the resin tube, it is desired that the gradient constitution of the barrier layer is composed of plural layers, and the outermost layer comprises 0.1 to 30% by weight, desirably 1 to 10% by weight of a barrier component, and the innermost layer comprises 0.1 to 30% by weight, desirably 0.5 to 3% by weight of an adhesive component.

To provide a resin tube excellent in various characteristics including mechanical characteristics, it is desired that the body layer comprises a polyamide resin.

For excellent mechanical strength, melt processability etc., it is desired that the barrier component is based on a fluorine resin, particularly ETFE, and the adhesive component is based on a modified fluorine resin, particularly modified ETFE.

To dissipate static charge, it is desired that the barrier component is blended with a conductive filler such as carbon black.

To facilitate production, the multi-layer resin tube has a three-layer structure including two layers in the barrier layer and one body layer.

### BRIEF DESCRIPTION OF DRAWINGS

FIG. 1 is a section showing the constitution of the multi-layer resin tube of this invention.

FIG. 2 is a section showing the constitution of the resin tube of this invention which is three-layered.

FIG. 3 is an outline of a method of molding the resin tube of this invention.

### BEST MODE FOR CARRYING OUT THE INVENTION

Hereinafter, the embodiments of this invention are described in detail.

The multi-layer resin tube of this invention is a fuel tube for automobiles, which is used for controlling the amount of permeating fuel.

The multi-layer resin tube is used mainly for the purpose of controlling the amount of permeating hydrocarbons, and is applicable to general-purpose fuels such as gasoline, diesel fuel, LPG, CNG etc. containing a small amount of an alcohol etc.

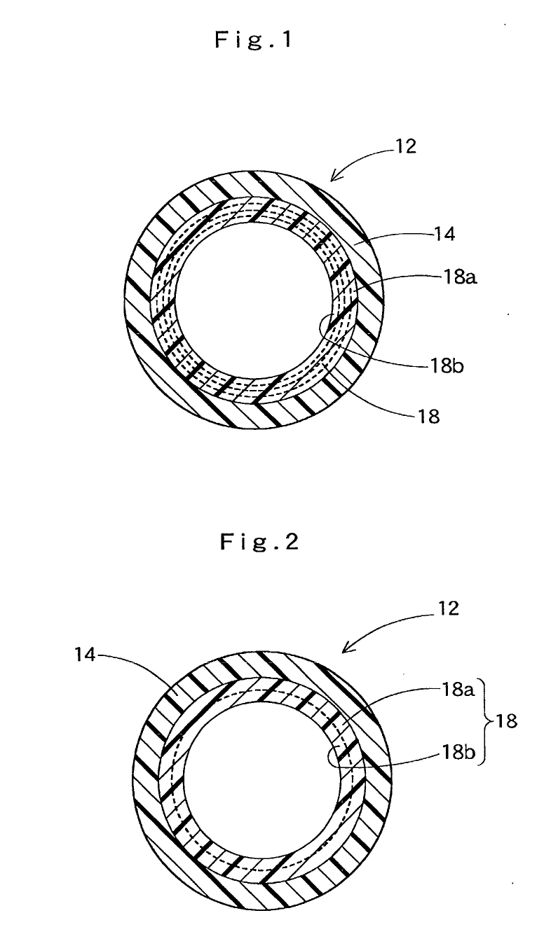

FIG. 1 shows the multi-layer resin tube 12 of this invention. The multi-layer resin tube 12 of this invention is characterized basically by being provided with a body layer 14 consisting of a thermoplastic resin and a barrier layer 18 consisting of a thermoplastic resin controlling fuel permeation in this order from the side of the outer layer.

Each layer is formed from a thermoplastic resin. The thermoplastic resin can be easily molded by extrusion molding described later.

Then, the barrier layer 18 is characterized by being gradient-constituted such that said layer is rich in an adhesive component at the side of the outer layer and rich in a barrier component at the side of the inner layer. By the gradient constitution, improvements in the adhesion among the respective layers in the barrier layer 18 can be expected.

The gradient constitution refers to a constitution where the composition varies successively in the direction of thickness. By adopting the above-described constitution, various characteristics can be gradually changed owing to the gradient composition of the material.

The conventional resin tube was provided separately with an independent adhesive layer, and the adhesion was improved by attracting attention on the material used in the adhesive layer, while the resin tube of the present invention was made from a different standpoint, that is, by providing it with a barrier layer containing both an adhesive component and a barrier component, and the adhesion was improved by attracting attention on the constitution of the barrier layer, so the present invention is based on the novel idea absent in the prior art.

The gradient constitution of the barrier layer 18 is composed of plural layers, and the outermost layer 18a comprises 0.1 to 30% by weight, desirably 0.5 to 20% by weight and more desirably 1 to 10% by weight of a barrier component, and the innermost layer 18b comprises 0.1 to 30% by weight, desirably 0.3 to 15% by weight and more desirably 0.5 to 3% by weight of an adhesive component.

That is, layers different in the amounts of the adhesive component and the barrier component are arranged sequentially so as to change their composition successively (stepwise) to form the barrier layer 18.

Accordingly, the difference in polarity between different kinds of materials and the difference in expansion coefficient therebetween can be reduced, and forcible interlaminar adhesion can be prevented. Accordingly, the problem of adhesion in the boundary between the layers can be solved.

FIG. 1 shows a five-layer resin tube including four layers in the barrier layer 18 and one body layer, but the present invention encompasses a resin tube designed to have two or more layers in the barrier layer 18.

When the content of the barrier component in the outermost barrier layer 18a is too high, the adhesion of the outermost barrier layer 18a to the body layer is lowered. On the other hand, if the content is too low, the characteristics of the gradient constitution are hardly exhibited. Further, when the content of the adhesive component in the innermost barrier layer 18b is too high, the barrier property is lowered. On the other hand, if the content is too low, the characteristics of the gradient component are hardly exhibited.

The body layer 14 is composed desirably of polyamides. This is because polyamides have been practically used, and are excellent as tubes in physical compatibility in respect of elongation, strength etc.

Among polyamides, aliphatic polyamides are used in principle. Specifically, use is made of nylon 12, nylon 11, nylon 6, nylon 66, nylon 610 etc. These are known as general-purpose polyamides to those skilled in the art, and any of them can be used.

In particular, nylon 11 and 12 are excellent in impact resistance, frictional and abrasion resistance, low-temperature characteristics, plasticity, flexibility, weather ability, oil resistance, chemical resistance, adhesion, dimensional stability etc.

Further, the term “polyamides” also encompasses additives such as plasticizer, flame-retardant and stabilizer.

It is desired that the barrier component is based on a fluorine resin, and the adhesive component is based on a modified fluorine resin.

The fluorine resin is highly stable to a change in temperature and suitable as a resin tube material. Further, the fluorine resin is chemically inert and thus hardly causes the interaction resulting from reaction with fuels. In addition, the fluorine resin is characterized by having significantly lower fuel permeability than that of the polyamide.

When the fluorine resin used in the barrier component is identical to the fluorine resin, before modification, in the modified fluorine resin used in the adhesive component, the adhesion can easily be improved. As a matter of course, fluorine resins that are different from each other can also be selected.

Examples of the fluorine resin include a tetrafluoroethylene-ethylene copolymer (ETFE), polytetrafluoroethylene (PTFE), polychlorotrifluoroethylene (PCTTE), tetrafluoroethylene perfluoroalkyl vinyl ether copolymer (PFA), tetrafluoroethylene-hexafluoropropylene copolymer (FEP), chlorotrifluoroethylene-ethylene copolymer (ECTEE), polyvinylidene fluoride (PVDF), polyvinyl fluoride (PVF) and tetrafluoroethylene-hexafluoropropylene-vinylidene fluoride copolymer (THV).

Particularly, ETFE is desirable because it is excellent in mechanical strength, chemical resistance etc. and easily melt-moldable. Accordingly, when the barrier component is based on ETFE while the adhesive component is based on modified ETFE, high-quality multi-layer resin tubes can be produced.

The modified fluorine resin used in the adhesive layer 16 is a fluorine resin modified for the purpose of improving the adhesion between the body layer 14 and the barrier layer 18. This modification is conducted in consideration of various conditions such that while the adhesion to the resin constituting the body layer 14 is improved, the interlaminar strength in the barrier layer is not lowered.

The modified fluorine resin includes a fluorine resin having a functional group introduced into the molecule thereof a fluorine resin having a functional group introduced into the terminal thereof, or the like.

The fluorine resin having a functional group introduced into the molecule thereof is a resin obtained by mixing a monomer having an adhesive functional group with a fluorine resin and polymerizing the mixture.

The adhesive functional group is a functional group capable of improving adhesion by e.g. the interaction thereof with a functional group contained in the polyamide forming the body layer 14.

Examples of the adhesive functional group include a hydroxyl group, carboxyl group, carbonyl group, epoxy group, amide group, amino group, amino group, aldehyde group, methylol group, sulfate group (sulfinyl group, sulphenyl group, sulfonyl group), phosphate group (phosphinyl group), unsaturated hydrocarbon group, carboxylic anhydride group and hydrolysable silyl group.

Examples of the monomer having an adhesive functional group include vinyl alcohol, acrylamide, ethylene oxide, acrylic acid, ethylenesulfonic acid, ethylene imine, vinyl pyridine, etc.

On the other hand, the fluorine resin having a functional group introduced into the terminal thereof is a resin obtained by cleaving a polymerized molecule by cleavage reaction and then introducing an adhesive functional group to the resulting molecule.

The adhesive functional group includes those groups exemplified above for the fluorine resin having a functional group introduced into the molecule thereof.

The cleavage reaction includes a method of irradiating the fluorine resin with high-energy rays such as radiations, UV rays, constant-temperature plasma etc., a method of using heating treatment, and a method of using free radicals, and any of such methods can be preferably used.

The above modified fluorine resin alters in properties by changing the molecular weight. As the molecular weight is increased, the adhesion is lowered while elongation and strength tend to be improved. On the other hand, as the molecular weight is decreased, the adhesion is improved while both elongation and strength tend to be lowered.

The desired adhesive strength between the body layer 14 and the outermost barrier layer 18a, in terms of interlaminar strength (or ply-separation strength), is at least 20 N/cm, desirably at least 30 N/cm, the tensile strength of the barrier layer is at least 20 MPa, desirably at least 30 MPa, and the elongation of the barrier layer is at least 200%, desirably at least 300%.

Further, the barrier component is endowed preferably with electrical conductivity by incorporation of a conductive filler. By endowing it with electrical conductivity, static charge which upon passage of fuel through the tube, is generated by the friction between the tube and fuel can be prevented from being accumulated.

The conductive filler can be uniformly dispersed as a compound with ETFE.

If the amount of the conductive filler is too high, the adhesion between the barrier layer 18 and body layer 14 is undesirably lowered. On the other hand, if the amount is too low, the electrical conductivity is undesirably low. The conductive filler is contained in such an amount that from the viewpoint of electrical conductivity, the volume resistance (SAE) of the barrier layer 18 is not greater than 10⁸Ω/sq, preferably not greater than 10⁶Ω/sq, and from the viewpoint of adhesion, ply separation does not occur.

Examples of the conductive filler include carbon black, silver, nickel, palladium, copper, gold, silicon etc. In particular, carbon black is preferable because it is inexpensive among general-purpose conductive fillers, and can be easily handled. Carbon black is in a powdery, fibrous or granular form, any of which can be used. Heretofore, a tube endowed with electrical conductivity by incorporating carbon black into a barrier layer has been proposed. In such a conventional tube, only the layer containing carbon black is black, and the boundary between the layers is remarkable in appearance. In the present invention, however, the gradient constitution of the barrier layer allows carbon black to be contained as a whole so that the whole of the barrier layer has almost the same color, to bring about an additional effect that the boundaries among the respective layers therein are hardly noticed.

For easy molding, it is desired that as shown in FIG. 2, the above resin tube is constructed to have three layers consisting of two layers in the barrier layer 18 and one body layer.

It is considered that when the barrier layer 18 has an gradient constitution of two layers, the change in the composition thereof is not as smooth as that of the barrier layer consisting of three or more layers, but productivity is improved and the number of layers is reduced, thus practically economizing on expensive facilities. Even if the barrier layer is two-layered, it is possible to maintain adhesion strength enough to prevent ply separation, under the conditions for the composition, material etc. described above.

The thickness of each layer should be suitably established depending on the characteristics required of a resin hose used.

The body layer should have certain thickness enough to absorb mechanical impact, vibration etc. exerted from the outside. The barrier layer should have certain thickness to satisfy the barrier property and electrical conductivity.

For example, as a general-purpose resin tube having a thickness of 1 mm, a high-quality tube can be obtained by producing the three-layered resin tube of this invention having the body layer of 0.8 mm in thickness, the outermost barrier layer of 0.1 mm in thickness and the innermost barrier layer of 0.1 mm in thickness.

There is also a resin tube having varying thickness, which is used usually as a fuel tube for automobiles (the total thickness of all layers is usually 0.25 to 2.0 mm), where if the body layer: outermost barrier layer: innermost barrier layer is 9:0.5:0.5-7:1.5:1.5, desirably about 8:1:1, though depending on the required barrier property, then conditions such as barrier property, strength etc. are satisfied.

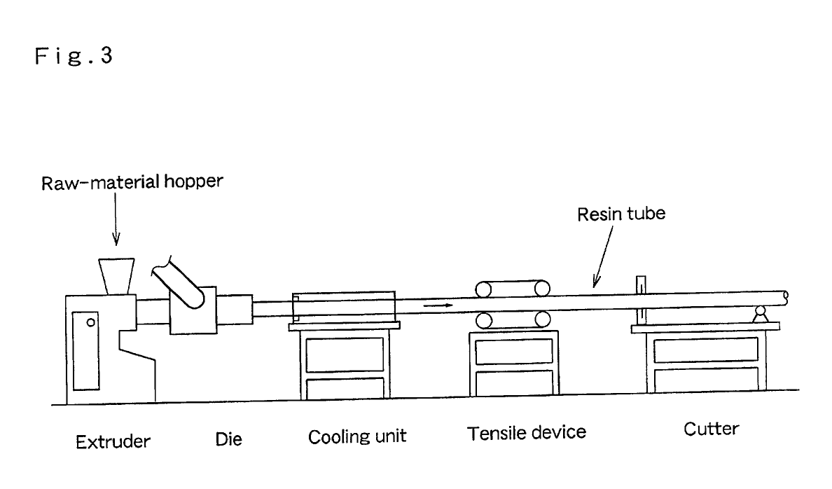

The multi-layer resin tube 12 is molded through an extrusion process. Usually, a resin constituting each layer is heated and molten in an extruder and co-extruded through a die for thermal fusion among the respective layers. The resulting resin tube may be co-extruded into a tube of suitable length or cut into tubes of predetermined length to give products. FIG. 3 shows an outline of this extrusion molding.

As the extruder, a general-purpose multi-color extruding device capable of co-extrusion is used. As the die used for tube molding, a crosshead die or offset die capable of molding multi-layer tubes can be used. Further, resins constituting the respective layers are joined for thermal fusion in the die, and for this fusion, either one-point fusion or successive fusion may be selected.

The line rate at the time of extrusion is regulated depending on the extrusion rate of the resin from an extruder and on a tensile device, and can influence the properties of the resin tube. When the line rate is too high, the adhesion strength between the body layer 14 and the barrier layer 18 is lowered thus permitting to ply separation to occur easily. This is probably because the heating time on the die is reduced and thus the reaction time between the body layer 14 and the barrier layer 18 is reduced.

The extrusion temperature shall be a temperature of from the glass transition point to the softening point of the resin used. If the extrusion temperature is too low, uniform processing of the resin is insufficient and its adhesion is not good. On the other hand, if the extrusion temperature is too high, the resin is undesirably deteriorated.

Hereinafter, the Examples of this invention are described. The three-layer resin tubes formed in the Examples have used the following materials. Body layer: Nylon 12 (containing 5% plasticizer) Outermost barrier layer: Modified ETFE (97 wt−%)+conductive ETFE (3 wt−%) Innermost barrier layer: Modified ETFE (1 wt−%)+conductive ETFE (99 wt−%)

Modified ETFE: ETFE TD-2000 manufactured by Asahi Glass Co., Ltd.

Conductive ETFE: ETFE CB-4015L manufactured by Asahi Glass Co., Ltd.

Electrical conductivity has been conferred by carbon black. The content of carbon black is 14 weight−% in the barrier component.

In the Examples, extrusion molding was conducted by using a three-color extruder at a temperature of 260° C. in an extrusion-molding die.

### EXAMPLE 1

Extrusion molding was conducted at two extrusion rates, that is, 4 m/min. and 8 m/min., to give resin tubes having the body layer of 0.8 mm in thickness, the outermost barrier layer of 0.1 mm in thickness, and the innermost barrier layer of 0.1 mm in thickness.

\mathring{1} Measurement Of The Adhesion Strength

On the basis of JIS K 6854, a ply-separation test with separation at 180° was conducted.

However, the interlaminar adhesion was so high that the layers themselves could not be subjected to a tester, and no separation occurred.

\mathring{2} Measurement of Fuel Permeation

The fuel permeation of the above tubes was measured. For this measurement, SHED (Sealed Housing for Evaporative Determination) method was used.

As a result, the amount of permeating hydrocarbons was not greater than 4 mg/m day, and the desired level was satisfied. This amount is considerably lower than the amount of permeating fuel through a single-layer nylon tube, and can be said to cope with the environmental regulation.

### EXAMPLE 2

Molding was conducted at varying extrusion rates to give tubes having the body layer of 0.8 mm in thickness, the outermost barrier layer of 0.1 mm in thickness and the innermost barrier layer of varying thickness.

\mathring{3} Measurement of the Electrical Conductivity

The innermost barrier layer in the three-layer tube having the above constitution was measured for its volume resistance by the measurement method of SAE J 2260 (Society of Automotive Engineers). The volume resistance thus determined satisfied the requirement for not greater than 1×10⁶Ω/sq.

### Industrial Applicability

This invention can improve the adhesion among barrier layers by using a gradient constitution where barriers layers comprise an adhesive component at the outside and a barrier component at the inside.

By modifying fluorine resin used in the barrier layer, the adhesion between the barrier layer and the body layer can be improved.

Further, the barrier layer has a gradient constitution, so there is brought about an additional effect that when a conductive filler is contained in the barrier component, the whole of the barrier layer exhibits almost the same color, and the boundaries among the respective layers therein are hardly noticed.

1. A multi-layer resin tube used as a fuel tube for automobiles, which is provided with a body layer consisting of a thermoplastic resin and a barrier layer consisting of a thermoplastic resin controlling fuel permeation in this order from the side of an outer layer thereof,
wherein the barrier layer is gradient-constituted such that said layer is rich in an adhesive component at the side of an outer layer and to be rich in a barrier component at the side of an inner layer.

2. The multi-layer resin tube according to claim 1, wherein the gradient constitution of the barrier layer is composed of plural layers, and the outermost layer comprises 0.1 to 30% by weight of a barrier component, and the innermost layer comprises 0.1 to 30% by weight of an adhesive component.

3. The multi-layer resin tube according to claim 2, wherein the gradient constitution of the barrier layer is composed of plural layers, and the outermost layer comprises 1 to 10% by weight of a barrier component, and the innermost layer comprises 0.5 to 3% by weight of an adhesive component.

4. The multi-layer resin tube according to claim 2, wherein the body layer comprises a polyamide.

5. The multi-layer resin tube according to claim 4, wherein the barrier component is based on a fluorine resin, and the adhesive component is based on a modified fluorine resin.

6. The multi-layer resin tube according to claim 5, wherein the barrier component is based on an ethylene-tetrafluoroethylene copolymer (referred to hereinafter as “ETFE”) and the adhesive component is based on a modified ethylene-tetrafluoroethylene copolymer (referred to hereinafter as “modified ETFE”).

7. The multi-layer resin tube according to claim 6, wherein the barrier component is based on an ethylene-tetrafluoroethylene copolymer blended with a conductive filler (referred to hereinafter as “conductive ETFE”).

8. The multi-layer resin tube according to claim 7, wherein the conductive filler is carbon black.

9. The multi-layer resin tube according to claim 1, 2, 3, 4, 5, 6, 7 or 8, wherein the multi-layer resin tube has a three-layer structure including two layers in the barrier layer and one body layer.
